(19) United States
(12) Patent Application Publication
(10) Pub. No.: US 2024/0149408 A1
(43) Pub. Date: May 9, 2024

(54) HAND TOOL WITH ANGLE ADJUSTING MECHANISM

(71) Applicants: YI-FU CHEN, TAICHUNG CITY (TW); HE-QIAN CHEN, TAICHUNG CITY (TW)

(72) Inventors: YI-FU CHEN, TAICHUNG CITY (TW); HE-QIAN CHEN, TAICHUNG CITY (TW)

(21) Appl. No.: 17/979,774

(22) Filed: Nov. 3, 2022

(51) Int. Cl. B25B 23/00

(52) U.S. Cl. CPC B25B 23/0028; B25B 13/462

(57) ABSTRACT

A hand tool with angle adjusting mechanism includes a handle, a driving head, an engaging assembly and a button. The handle has a receiving groove, a transverse hole and a longitudinal hole. The driving head has a connecting portion disposed in the receiving groove. The engaging assembly has an engaging member and a spring. The engaging member has an engaging tooth at a top thereof for engagement with the driving head, and has an arc-shape pushing groove in a lateral side with an arc-shape wall inside thereof. The button is movably disposed in the transverse hole of the handle, and has an abutting portion slidably inserted in the arc-shape pushing groove, the abutting portion of the button has an arc-shape plane abutting against the arc-shape wall such that horizontal movement of the button drives the engaging member to move longitudinally along the longitudinal hole of the handle.

### BACKGROUND OF THE INVENTION

### 1. Field of the Invention

The present invention relates to a hand tool and more particularly to a hand tool with an angle adjusting mechanism, in which an angle between a handle and a head member pivoted on the handle is adjustable.

### 2. Description of Related Art

A conventional ratchet wrench with angle adjusting mechanism has a handle and a driving head provided with a toothed protrusion. The handle has a forked end to receive the protrusion, wherein the head and the handle are hinged about a bolt therethrough. Between the tines of the fork is also disposed a gear having two different size diameters. This gear is provided on the shaft of a button which is spring loaded. In the normal position the large gear engages with the teeth of the protrusion on the head and the smaller gear engages with an inwardly toothed section of one tine of the fork such that the wrench head and handle are held rigid. When the button is depressed, the smaller gear disengages from the handle and the wrench head and handle are free to rotate with respect to each other. When the button is released, the spring loaded returns the gear to the normal position and the handle is fixed again.

However, the gear may not be completely engaged with and completely disengaged from the teeth of the driving head such that the rotational movement of the driving head may not be easily operated. In addition, a number of parts and elements are required and may not be easily assembled.

The present invention has arisen to mitigate and/or obviate the disadvantages of the conventional wrench.

### SUMMARY OF THE INVENTION

The main objective of the present invention is to provide an improved hand tool.

To achieve the objective, a hand tool comprises a handle, a driving head, an engaging assembly and a button. The handle has two pivot ears at one end thereof, a receiving groove defined between the two pivot ears, a transverse hole defined in one lateral side of the handle, and a longitudinal hole defined in a bottom of the receiving groove and in communication with the transverse hole. The driving head has a connecting portion received in the receiving groove of the handle, and a pivot shaft connecting the driving head to the two pivot ears of the handle. The connecting portion has a plurality of teeth at an outer periphery thereof and arranged in an arc. The engaging assembly is disposed in the longitudinal hole of the handle, and has an engaging member and a spring interposed between a bottom of the longitudinal hole and the engaging member. The engaging member has an engaging tooth at a top thereof for engagement with the teeth of the driving head, and has an arc-shape pushing groove defined in a lateral side of the engaging member and corresponding to the transverse hole of the handle. The arc-shape pushing groove has an arc-shape wall thereof, the arc-shape wall of the engaging member is concaved toward the direction of the spring from the lateral side of the engaging member. The button is movably disposed in the transverse hole of the handle, and has an abutting portion slidably inserted in the arc-shape pushing groove of the engaging member, the abutting portion of the button has an arc-shape plane abutting against the arc-shape wall of the engaging member such that horizontal movement of the button drives the engaging member to move longitudinally along the longitudinal hole of the handle, when the button is pushed toward the engaging member, the engaging member moves to compress the spring in the longitudinal hole of the handle and the engaging tooth of the engaging member is lowered to be disengaged from the teeth of the engaging member.

Preferably, each of the teeth of the connecting portion of the driving head and the engaging tooth of the engaging member are substantially rectangular-shaped.

Preferably, the radian of the arc-shape wall of the engaging member is greater than the radian of the arc-shape plane of the abutting portion.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a hand tool in accordance with a preferred embodiment of the present invention;

FIG. 2 is a perspective view of the hand tool shown in FIG. 1;

FIG. 3 is a cross-sectional view of the hand tool along line III-III of FIG. 2;

FIG. 3A is a partial enlarged view of the hand tool shown in FIG. 3;

FIG. 4 is another partial enlarged view of the hand tool shown in FIG. 3; and

FIG. 5 illustrates that the driving head is rotated relative to the handle of the hand tool shown in FIG. 3.

### DETAILED DESCRIPTION OF THE INVENTION

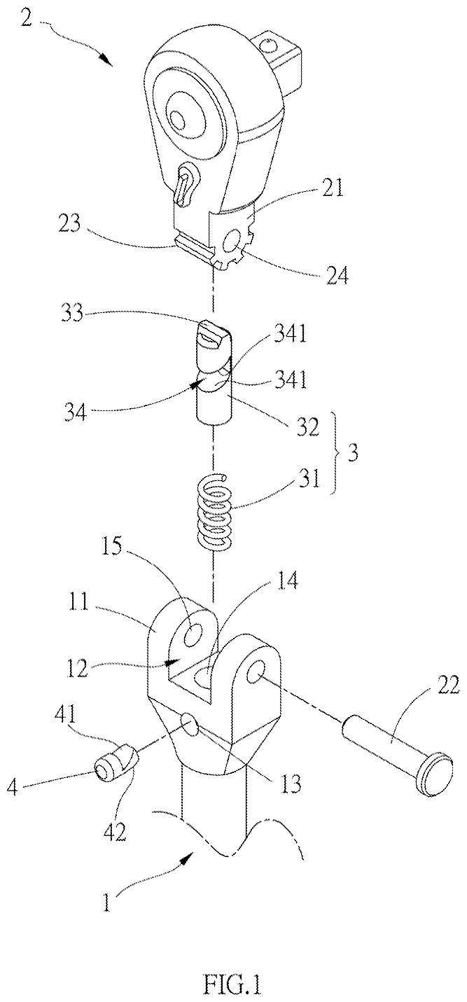

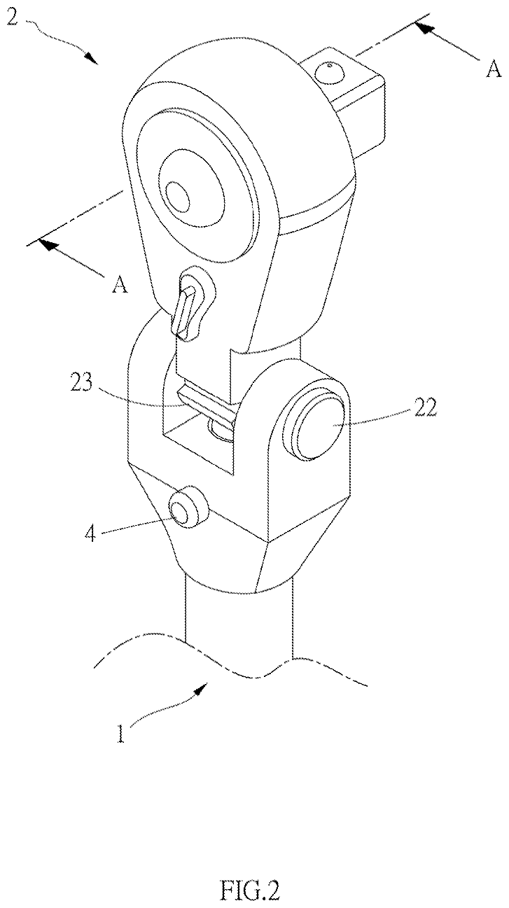

Referring to FIGS. 1-5, a hand tool with angle adjusting mechanism in accordance with a preferred embodiment of the present invention comprises a handle 1, a driving head 2, an engaging assembly 3 and a button 4. The handle 1 has two pivot ears 11 at one end thereof, a receiving groove 12 defined between the two pivot ears 11, a transverse hole 13 defined in one lateral side of the handle 1, and a longitudinal hole 14 defined in a bottom of the receiving groove 12 and in communication with the transverse hole 13. Each of the two pivot ears 11 has a through hole 15 therein. The driving head 2 has a connecting portion 21 received in the receiving groove 12 of the handle 1, and a connecting hole 24 defined therethrough. A pivot shaft 22 passes through the through hole 15 of each pivot ear 11 and the connecting hole 24 of the connecting portion 21 so as to secure the driving head 2 to the handle 1. Therefore, the driving head 2 is rotatable relative to the handle 1.

As shown in FIGS. 1-5, the connecting portion 21 has a plurality of teeth 23 at an outer periphery thereof and arranged in an arc. The engaging assembly 3 has an engaging member 32 and a spring 31 disposed in the longitudinal hole 14 of the handle 1. The spring 31 is interposed between a bottom of the longitudinal hole 14 and the engaging member 32. The engaging member 32 has an engaging tooth 33 at a top thereof for engagement with the teeth 23 of the driving head 2. Specifically, the engaging member 32 has an arc-shape pushing groove 34 defined in a lateral side of the engaging member 32 and corresponding to the transverse hole 13 of the handle 1. The arc-shape pushing groove 34 has an arc-shape wall 341 thereof, the arc-shape wall 341 of the engaging member 32 is concaved toward the direction of the spring 31 from the lateral side of the engaging member 32. The button 4 is movably disposed in the transverse hole 13 of the handle 1, and has an abutting portion 41 slidably inserted in the arc-shape pushing groove 34 of the engaging member 32, the abutting portion 41 of the button 4 has an arc-shape plane 42 abutting against the arc-shape wall 341 of the engaging member 32 such that horizontal movement of the button 4 drives the engaging member 32 to move longitudinally along the longitudinal hole 14 of the handle 1, when the button 4 is pushed toward the engaging member 32, the engaging member 32 moves to compress the spring 31 in the longitudinal hole of the handle 1 and the engaging tooth 33 of the engaging member 32 is lowered to be disengaged from the teeth 23 of the engaging member 32.

The arc-shape structure of the arc-shape pushing groove 34, arc-shape wall 341, and arc-shape plane 42 makes the operation of pushing the button 4 toward the engaging member 32 smoother.

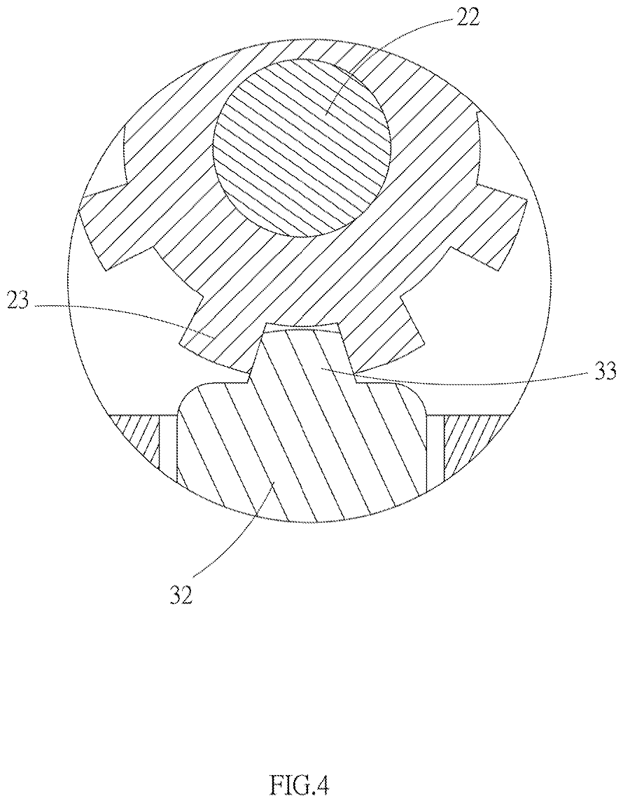

As shown in FIG. 4, each of the teeth 23 of the connecting portion 21 of the driving head 2 is substantially rectangular-shaped. Besides, the engaging tooth 33 of the engaging member 32 is substantially rectangular-shaped. In this configuration, the engaging tooth 33 of the engaging member 32 could be steadily engaged with the teeth 23 of the connecting portion 21 of the driving head 2 such that the driving head 2 could be positioned in a certain angle relative to the handle 1.

Furthermore, the radian of the arc-shape wall 341 of the engaging member 32 is greater than the radian of the arc-shape plane 42 of the abutting portion 41.

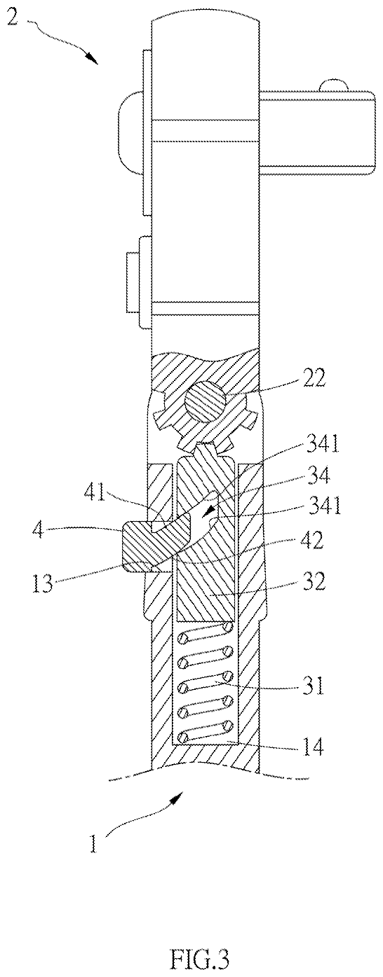

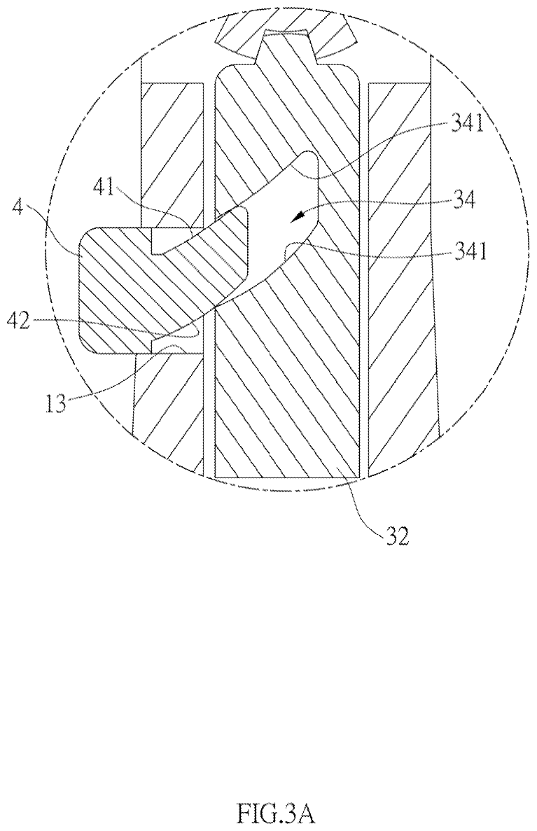

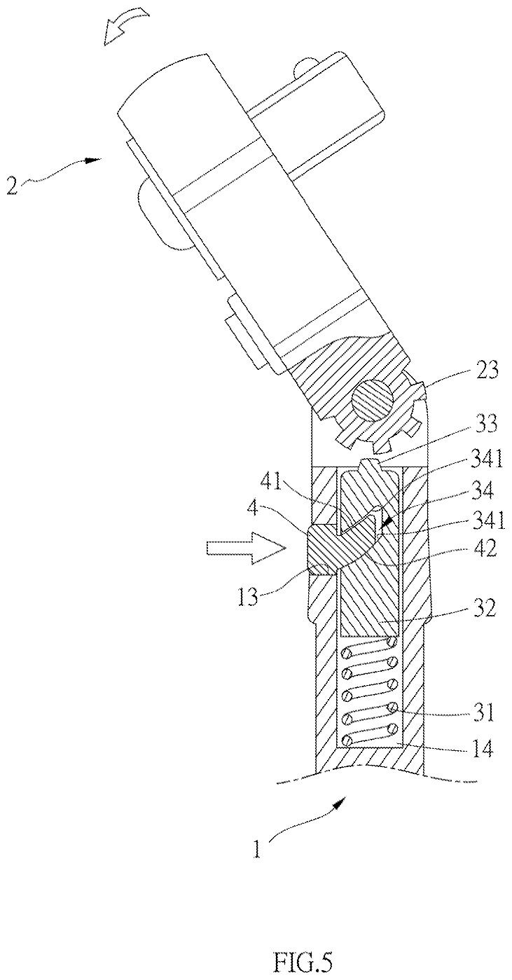

The detail descriptions of the operation are shown as following. Generally, the spring 31 abuts against the engaging member 32 toward the driving head 2 such that the engaging tooth 33 of the engaging member 32 is engaged with the teeth 23 of the connecting portion 21 to secure the driving head 2, as shown in FIG. 3. Referring to FIG. 5, when the button 4 is pushed inward, the arc-shape plane 42 of the abutting portion 41 abuts against the arc-shape pushing groove 34 of the engaging member 32 such that the engaging member 32 is moved downwardly along the longitudinal hole 14 of the handle 1 while the spring 31 is biased. Therefore, the angle of the driving head 2 could be adjusted relative to the handle 1. In contrast, when the button 4 is released, the engaging member 32 is pushed by the spring 31 via the recovery force while the engaging tooth 33 of the engaging member 32 is engaged with the teeth 23 of the connecting portion 21 so as to secure the driving head 2 in an appropriate angle.

Although the invention has been explained in relation to its preferred embodiment, it is to be understood that many other possible modifications and variations can be made without departing from the scope of the invention as hereinafter claimed.

What is claimed is:

1. A hand tool, comprising:
a handle having two pivot ears at one end thereof, a receiving groove defined between the two pivot ears, a transverse hole defined in one lateral side of the handle, and a longitudinal hole defined in a bottom of the receiving groove and in communication with the transverse hole;
a driving head having a connecting portion received in the receiving groove of the handle, and a pivot shaft connecting the driving head to the two pivot ears of the handle, the connecting portion having a plurality of teeth at an outer periphery thereof and arranged in an arc;
an engaging assembly disposed in the longitudinal hole of the handle, and having an engaging member and a spring interposed between a bottom of the longitudinal hole and the engaging member; the engaging member having an engaging tooth at a top thereof for engagement with the teeth of the driving head, and having an arc-shape pushing groove defined in a lateral side of the engaging member and corresponding to the transverse hole of the handle, the arc-shape pushing groove having an arc-shape wall thereof, the arc-shape wall of the engaging member is concaved toward the direction of the spring from the lateral side of the engaging member; and
a button movably disposed in the transverse hole of the handle, and having an abutting portion slidably inserted in the arc-shape pushing groove of the engaging member, the abutting portion of the button having an arc-shape plane abutting against the arc-shape wall of the engaging member such that horizontal movement of the button drives the engaging member to move longitudinally along the longitudinal hole of the handle, when the button is pushed toward the engaging member, the engaging member moves to compress the spring in the longitudinal hole of the handle and the engaging tooth of the engaging member is lowered to be disengaged from the teeth of the engaging member.

2. The hand tool as claimed in claim 1, wherein each of the teeth of the connecting portion of the driving head is substantially rectangular-shaped.

3. The hand tool as claimed in claim 1, wherein the engaging tooth of the engaging member is substantially rectangular-shaped.

4. The hand tool as claimed in claim 1, wherein the radian of the arc-shape wall of the engaging member is greater than the radian of the arc-shape plane of the abutting portion.
